(19) United States
(12) Patent Application Publication
(10) Pub. No.: US 2024/0264713 A1
(43) Pub. Date: Aug. 8, 2024

(54) DISPLAY MODULE, ELECTRONIC TERMINAL AND POSITION DETECTION METHOD

(71) Applicants: Beijing BOE Technology Development Co., Ltd., Beijing (CN); BOE TECHNOLOGY GROUP CO., LTD., Beijing (CN)

(72) Inventors: Zongmin LIU, Beijing (CN); Yali WANG, Beijing (CN); Biqi LI, Beijing (CN); Feng QU, Beijing (CN); Jijing HUANG, Beijing (CN)

(21) Appl. No.: 18/021,585

(22) PCT Filed: Mar. 29, 2022
(86) PCT No.: PCT/CN2022/083731

§ 371 Date: Feb. 16, 2023

(51) Int. Cl. G06F 3/046; G02F 1/1333; G02F 1/1335; G06F 3/041; H01Q 1/22; H01Q 1/38

(52) U.S. Cl. CPC G06F 3/046; G02F 1/13338; G02F 1/133514; G06F 3/0412; G06F 3/0416; H01Q 1/22; H01Q 1/38

(57) ABSTRACT

The present disclosure provides a display module, a position detection method for the display module and an electronic terminal, and belongs to the field of display technology. The present disclosure provides a display module, including: a display panel and a plurality of antenna units integrated on the display panel. The display panel includes a plurality of pixel units, and any one of the plurality of pixel units is covered by beams radiated by at least three antenna units at a center frequency.

### TECHNICAL FIELD

The present disclosure relates to the field of display technology, and in particular to a display module, an electronic terminal and a position detection method.

### BACKGROUND

With the rapid development of display technology, a display device including a touch screen panel has been widely used in human lives. According to the operating principle of the touch screen panel, the touch screen panel may be classified as: a capacitive touch screen panel, a resistive touch screen panel, an infrared touch screen panel, a surface acoustic wave touch screen panel, an electromagnetic touch screen panel, a vibration wave induction touch screen panel, and the like. The capacitive touch screen panel has the advantages of multi-touch function, strong noise immunity, mature technology, low cost for manufacturing and the like, and thus has been a mainstream technology for a consumer electronic product such as a mobile phone, a tablet computer and the like.

An operating principle of the capacitive touch screen panel in the prior art is that: a first electrode and a second electrode (i.e., touch electrodes) are provided on a substrate and are configured to determine position information of touch points, and the touch electrodes in a same row or in a same column are electrically connected to each other by digging holes so as to determine coordinates of the touch points on an X axis or a Y axis. The capacitive touch screen panel is commonly used in a small-sized display panel. When the capacitive touch screen panel is applied to a large-sized or ultra-large-sized display panel, a high cost is required to realize a touch function.

### SUMMARY

The present disclosure is directed to at least one of the technical problems of the prior art, and provides a display module, an electronic terminal and a position detection method.

In a first aspect, the present disclosure provides a display module, including: a display panel and a plurality of antenna units integrated on the display panel; wherein the display panel includes a plurality of pixel units; and any one of the plurality of pixel units is covered by beams radiated by at least three antenna units at a center frequency.

Wherein the display panel includes a first substrate and a second substrate opposite to each other, and a liquid crystal layer between the first substrate and the second substrate; each antenna unit includes a first radiation part and a reference electrode opposite to each other; the first radiation part is integrated on the second substrate, and the reference electrode is integrated on the first substrate.

Wherein the first substrate includes a first base substrate and a driving layer on a side of the first base substrate close to the liquid crystal layer; the driving layer is used as reference electrodes of the plurality of antenna units.

Wherein the second substrate includes a second base substrate and a color filter layer on a side of the second base substrate close to the liquid crystal layer; the first radiation part of each antenna unit is on a side of the first base substrate away from the color filter layer.

Wherein a first radiation layer is integrated on the second substrate; the first radiation part of each antenna unit is in the first radiation layer; the first radiation layer further includes a plurality of redundant radiation parts, each of which is between the any two adjacent first radiation parts, and the plurality of redundant radiation parts are separated apart from the first radiation parts.

Wherein the first radiation layer includes a metal mesh structure; the metal mesh structure includes a plurality of first metal lines and a plurality of second metal lines crossing with the plurality of first metal lines; and the plurality of first metal lines and the plurality of second metal lines are broken at interface positions of the first radiation parts and the redundant radiation parts.

Wherein the antenna unit is a directional antenna.

Wherein the antenna unit is a Yagi-Uda antenna.

Wherein a frequency band of the electromagnetic waves radiated by each antenna unit is a millimeter-wave band.

Wherein the display module further includes: a control unit and a data processing unit; wherein the control unit is configured to control each antenna unit to radiate electromagnetic waves of a first frequency and receive the electromagnetic waves reflected by a touch object according to a position of the touch object to be detected; and the data processing unit is configured to generate the position of the touch object to be detected according to the first frequency and a frequency of the reflected electromagnetic wave.

Wherein the display module further includes: a signal transmission unit; wherein a first end of the signal transmission unit is communicatively connected to the plurality of antenna units, and a second end of the signal transmission unit is communicatively connected to the data processing unit and/or the control unit.

Wherein the signal transmission unit includes a first signal transmission part, a second signal transmission part, and a third signal transmission part between the first signal transmission part and the second signal transmission part; the first signal transmission part covers the first end of the signal transmission unit; the second signal transmission part covers the second end of the signal transmission unit; the first signal transmission part and the second signal transmission part include ACF glue; and the third signal transmission part includes an LCP base material and a signal line.

Wherein the signal line includes at least one of a micro-strip line or a strip line.

Wherein the data processing unit includes a signal generation sub-module, a power division sub-module, a mixing sub-module, an intermediate frequency signal processing sub-module, an analog-to-digital conversion sub-module, a baseband signal processing sub-module, and a position calculation sub-module; the signal generation sub-module is configured to generate a first reference signal according to the first frequency; the power division sub-module is configured to generate a first reference sub-signal according to the first reference signal; a frequency of the first reference sub-signal includes the first frequency; the mixing sub-module is configured to generate a first mixing signal according to the reflected signal received by each antenna unit and the first reference sub-signal; the intermediate frequency signal processing sub-module is configured to generate a first intermediate frequency signal according to the first mixing signal; the analog-to-digital conversion sub-module is configured to generate a first digital signal according to the first intermediate frequency signal; the baseband signal processing sub-module is configured to generate distance information according to the first digital signal; and the position calculation sub-module is configured to generate the position of the touch object to be detected according to a plurality of groups of the distance information.

In a second aspect, the present disclosure provides a position detection method for the above display module, wherein the display module includes N groups of antenna units, and the position detection method includes: radiating, by an ith group of antenna units, the electromagnetic waves of the first frequency; receiving, by the ith group of antenna units, the electromagnetic waves of a second frequency; generating, by the data processing unit, an ith group of distance information according to the first frequency and the second frequency; and generating, by the data processing unit, the position of the touch object to be detected according to the N groups of distance information; where 1≤i≤N, 3≤N; i and N are both positive integers.

Wherein radiating the electromagnetic waves of the first frequency by a (j+1)th group of antenna units and generating a jth group of position information are performed simultaneously; where 1≤j<N; j is a positive integer.

In a third aspect, the present disclosure provides an electronic terminal, including the above display module.

Wherein the electronic terminal includes any one or more of a refrigerator, a washing machine, and a display device.

### BRIEF DESCRIPTION OF DRAWINGS

FIG. 1 illustrates an exemplary display panel;

FIG. 2 is a schematic cross-sectional view of the display panel shown in FIG. 1;

FIG. 3 is a schematic diagram of an equivalent circuit of a pixel unit in the display panel shown in FIG. 1;

FIG. 4 is a schematic diagram of an exemplary touch substrate;

FIG. 5 is a schematic diagram of a display module according to an embodiment of the present disclosure;

FIG. 6 is a schematic diagram of a Yagi-Uda antenna according to an embodiment of the present disclosure;

FIG. 7 is a schematic diagram of a display module according to an embodiment of the present disclosure;

FIG. 8 is a schematic diagram of a display module according to an embodiment of the present disclosure;

FIG. 9 is a schematic diagram of an enlarged part of a first radiation part according to an embodiment of the present disclosure;

FIG. 10 is another schematic diagram of an enlarged part of a redundant radiation part according to an embodiment of the present disclosure;

FIG. 11 is a schematic diagram of a display module according to an embodiment of the present disclosure;

FIG. 12 is a schematic diagram of a data processing unit according to an embodiment of the present disclosure;

FIG. 13 is a schematic diagram illustrating a flow chart of a position detection method according to an embodiment of the present disclosure; and

FIG. 14 is a schematic diagram illustrating a flow chart of a position detection method according to an embodiment of the present disclosure.

### DETAIL DESCRIPTION OF EMBODIMENTS

In order to enable one of ordinary skill in the art to better understand the technical solutions of the present disclosure, the present disclosure will be described in further detail with reference to the accompanying drawings and the detailed description.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”, “an”, “the”, or the like used herein does not denote a limitation of quantity, but rather denotes the presence of at least one element. The term “comprising”, “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may also be changed accordingly.

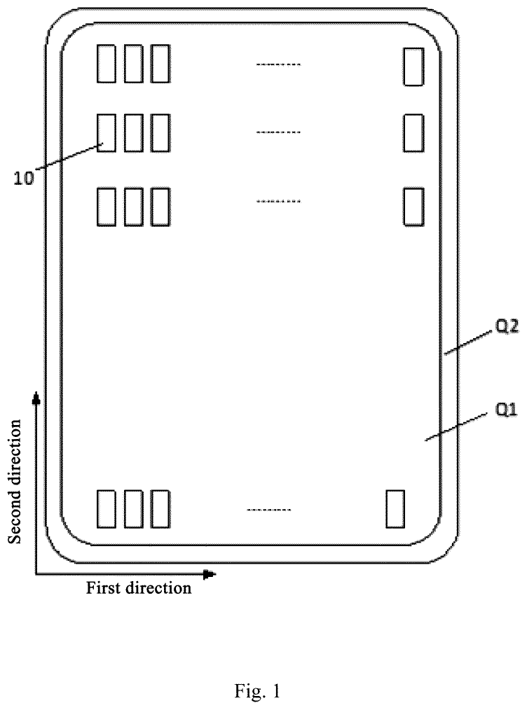

FIG. 1 is an exemplary display substrate. The display substrate includes a plurality of pixel units 10 arranged in an array along a first direction and a second direction, which intersect with each other; one of the first direction and the second direction is a row direction, and the other one is a column direction. In the embodiment of the present disclosure, as an example, the first direction is the row direction, and the second direction is the column direction. In the embodiment of the present disclosure, the plurality of pixel units 10 may include, but be not limited to, a red pixel unit 10, a green pixel unit 10, a blue pixel unit 10, and the like.

As shown in FIG. 1, the display panel includes a display region Q1 and a peripheral region Q2 surrounding the display region Q1; the display panel includes a display substrate and an opposite substrate which are arranged opposite to each other, and a liquid crystal layer 11 arranged between the display substrate and the opposite substrate. The display substrate and the opposite substrate are fixed together by a frame sealing adhesive 9 arranged in the peripheral region Q2. The display substrate may be an array substrate, and the opposite substrate may be a color filter substrate 13. Alternatively, the display substrate may alternatively be a COA substrate (Color On Array), and the opposite substrate may be a cover plate. In the embodiment of the present disclosure, as an example, the display substrate is the array substrate, and the opposite substrate is the color filter substrate 13.

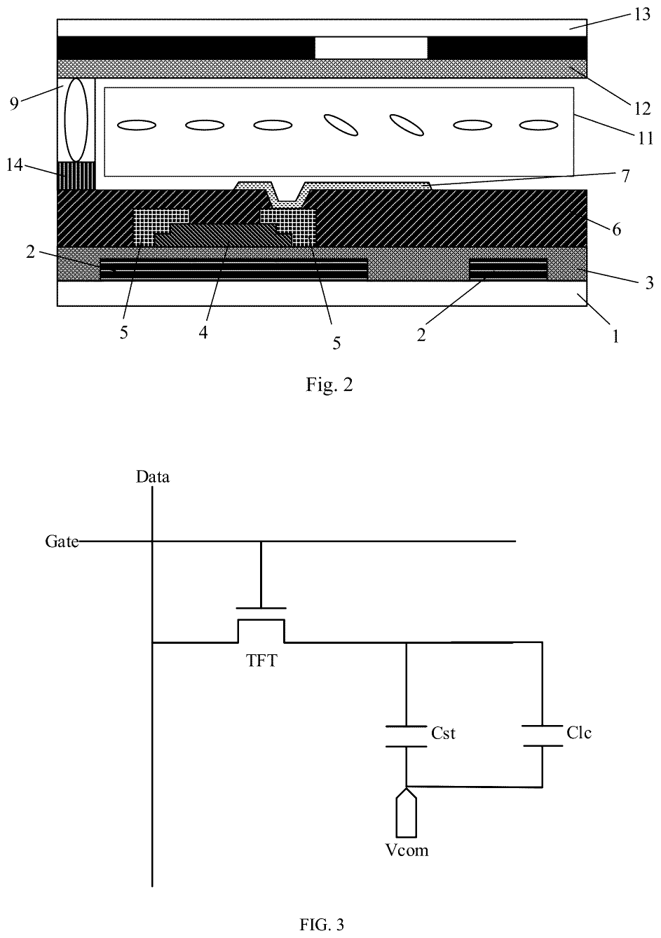

FIG. 2 is a cross-sectional view of the display substrate of FIG. 1. Referring to FIG. 2, a structure of the display substrate will be described in detail. As shown in FIG. 2, the display substrate includes a third base substrate 1, and the plurality of pixel units 10 disposed on the third base substrate 1; each pixel unit 10 has a structure including: a first metal layer 2, a first interlayer insulating layer 3, an active semiconductor layer 4, a second metal layer 5, a second interlayer insulating layer 6, a first transparent conductive layer, a liquid crystal layer 11 and a color filter substrate 13 sequentially arranged on the third base substrate 1. The first metal layer 2 is disposed on a side of the third base substrate 1, and includes control electrodes of thin film transistors (TFTs) located in the display region Q1, and a second plate of a storage capacitor Cst; the first interlayer insulating layer 3 is arranged on a side of the first metal layer 2 away from the third base substrate 1; the active semiconductor layer 4 is arranged on a side of the first interlayer insulating layer 3 away from the third base substrate 1, and the active semiconductor layer 4 includes channel regions and source-drain doped regions of thin film transistors in the display region Q1; the second metal layer 5 is disposed on a side of the active semiconductor layer 4 and the first interlayer insulating layer 3 away from the third base substrate 1, and includes first electrodes and second electrodes of thin film transistors in the display region Q1; the second interlayer insulating layer 6 and the first transparent conductive layer are respectively and sequentially arranged on a side of the second metal layer 5 away from the third base substrate 1, the first transparent conductive layer includes pixel electrodes 7 of pixel units 10 in the display region Q1, and each pixel electrode 7 is connected to a drain electrode of a corresponding thin film transistor TFT through a third connecting via extending through the second interlayer insulating layer 6. The color filter substrate 13 and the first transparent conductive layer are opposite to each other, and are connected to each other by the frame sealing adhesive 9; and the frame sealing adhesive 9 and the liquid crystal layer 11 are between the color filter substrate 13 and the second interlayer insulating layer 6. A common electrode 12 is provided on a side of the color filter substrate 13 close to the first transparent conductive layer.

FIG. 3 is a schematic diagram of an equivalent circuit of a pixel unit 10 in the display substrate. As shown in FIG. 3, the equivalent circuit includes a thin film transistor TFT, the storage capacitor Cst, a liquid crystal capacitor Clc; a first electrode of the thin film transistor TFT is connected to a data line, a second electrode of the thin film transistor TFT is connected to a first plate of the storage capacitor Cst and a first plate of the liquid crystal capacitor Clc, and a control electrode of the thin film transistor TFT is connected to a gate line; the second plate of the storage capacitor Cst is connected to the common electrode line 14; a second plate of the liquid crystal capacitor Clc is connected to a common electrode line 14. When the gate line is written with an operating level signal, the thin film transistor TFT is gated. A display of a corresponding gray scale is realized through a voltage signal of a data line written on the data line.

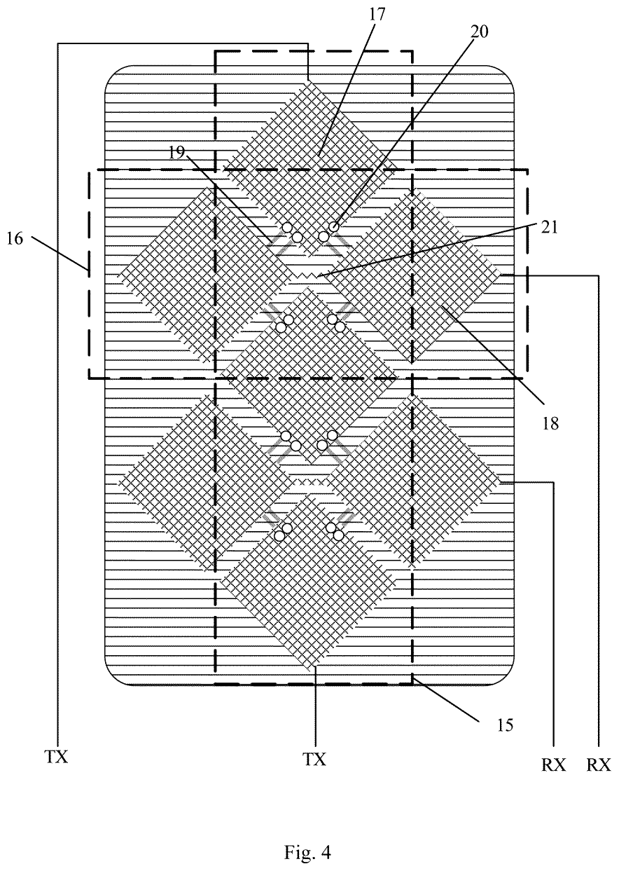

In an exemplary embodiment, with continued reference to FIG. 2, the exemplary display substrate further includes a touch substrate as shown in FIG. 4, such that the exemplary display substrate has a touch function. Referring to FIG. 4, specifically, the touch substrate includes a fourth base substrate, a plurality of first electrodes 15 disposed on the fourth base substrate and arranged side by side along the first direction, and a plurality of second electrodes 16 disposed on the fourth base substrate and arranged side by side along the second direction; each of the plurality of first electrodes 15 includes a plurality of first electrode blocks 17 arranged side by side along the second direction, and a plurality of first connecting parts 19, where one first connecting part 19 is connected between any adjacent first electrode blocks 17; each of the plurality of second electrodes 16 includes a plurality of second electrode blocks 18 arranged along the first direction, and a plurality of second connecting parts 21, where one second connecting part 21 is connected between any adjacent second electrode blocks 18. A first insulating layer is arranged between a layer where the first connecting part 19 is located and a layer where the first electrodes 15 and the second electrodes 16 are located, and is provided with a plurality of first vias 20 therein, and an orthographic projection of each first via 20 on the third base substrate 1 and an orthographic projection of a corresponding first connecting part 19 on the third base substrate 1 at least partially overlap with each other. Each first connecting part 19 is connected to a corresponding first electrode block 17 disposed adjacently to the first connecting part 19 through a corresponding first via 20.

In this exemplary touch substrate, as shown in FIG. 4, only one first electrode 15 and two second electrodes 16 are taken as an example in FIG. 4 for description. The first electrode blocks 17 and the second electrode blocks 18 are arranged in a matrix along the first direction and the second direction; the first electrode blocks 17 arranged along the second direction are electrically connected together sequentially through first adapter electrodes arranged in the first vias 20 and the first connecting parts 19 to form the first electrode 15; and the second electrode blocks 18 arranged along the first direction are electrically connected together sequentially through the second connecting parts 21 arranged in the same layer to form the second electrode 16. Each first electrode block 17 in one first electrode 15 and a corresponding second electrode block 18 in one second electrode 16 and adjacent to the first electrode block form a first coupling capacitor; and the plurality of first electrodes 15 and the plurality of second electrodes 16 form a plurality of first coupling capacitors arranged in an array on the fourth base substrate. When a touch object (such as a finger of a person) touches the touch substrate, the electric charges transmitted by driving electrodes are partially transmitted to the ground through the finger, the amount of the electric charges flowing through the first coupling capacitors is reduced, and the amount of the electric charges received by sensing electrodes at a touch position of the finger is obviously reduced, so that the touch position of the finger is determined.

In the exemplary display panel, when the display substrate is applied to a large-sized or ultra-large-sized display module, the cost for realizing the touch function is high in the display module. Meanwhile, due to structural limitations of the touch substrate, only a contact touch can be realized and a non-contact touch cannot be realized in the exemplary display panel.

In order to solve the above problem, the embodiment of the present disclosure provides a display module, an electronic terminal, and a position detection method.

In a first aspect, an embodiment of the present disclosure provides a display module, which includes a display panel 22 and a plurality of antenna units 23 integrated on the display panel 22. The display panel 22 includes a plurality of pixel units 10, and any one of the pixel units 10 is covered by beams radiated by at least three antenna units 23 at a center frequency. In the embodiment of the present disclosure, each pixel unit 10 emits light according to a picture to be displayed by the display module. Each antenna unit 23 radiates electromagnetic waves of a first frequency and receives electromagnetic waves reflected by a touch object. In the embodiment of the present disclosure, the touch object may be a finger of a person or a touch pen. The touch object is a finger of a person for description, as an example. Any one of the pixel units 10 is covered by beams radiated by at least three antenna units 23 at a center frequency, so that when the finger is located in a region where any one pixel unit 10 is located, the finger is covered by beams radiated by at least three antenna units 23 at the center frequency. At this time, the electromagnetic waves of the first frequency are radiated from any one of the antenna units 23 and are reflected by the finger, and the reflected electromagnetic waves are received by the antenna unit 23. A radiation frequency and a reception frequency of each antenna unit 23 are processed, to obtain information about a distance between the finger and the antenna unit 23. Since the finger is covered by the beams radiated by at least three antenna units 23 at the center frequency, position information of the finger may be obtained by calculating the information about the distance between the finger and the antenna unit 23. The position information of the finger may be mapped to the picture to be displayed by the display module, thereby realizing the touch of the finger on the display module.

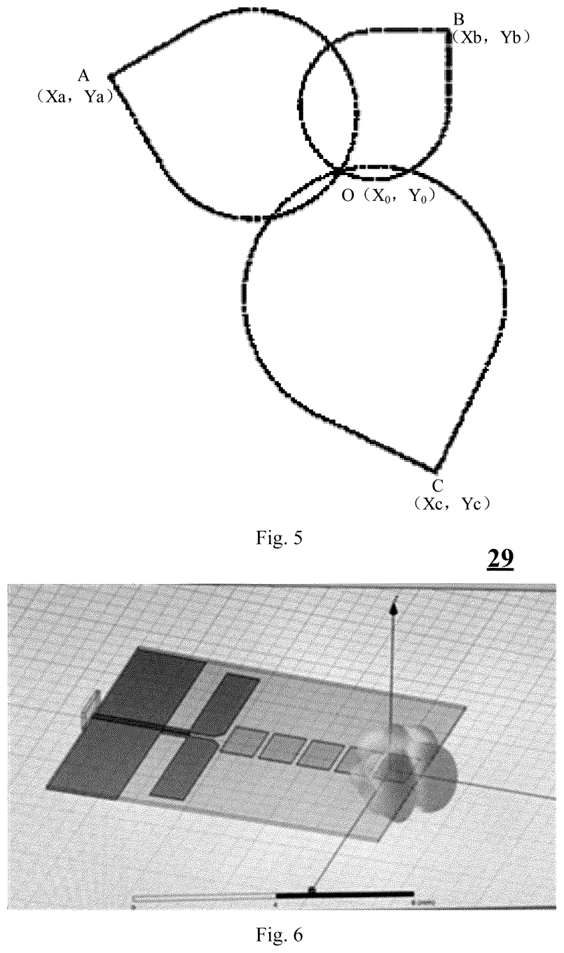

Specifically, as shown in FIG. 5, in the embodiment of the present disclosure, as an example, each pixel unit 10 is covered by beams radiated by three antenna units 23 at the center frequency for description. A coordinate of a first antenna unit A in a horizontal direction is (Xa, Ya); a coordinate of a second antenna unit B in the horizontal direction is (Xb, Yb); a coordinate of a third antenna unit C in the horizontal direction is (Xc, Yc). In this case, a distance between the finger and the first antenna unit A in the horizontal direction is X1=v*Δfa/2k; a distance between the finger and the second antenna unit B in the horizontal direction is X2=v*Δfb/2k; and a distance between the finger and the third antenna unit C in the horizontal direction is X3=v*Δfc/2k; where v is the speed of transmission for the electromagnetic wave, Δfa, Δfb and Δfc are a difference between a radiation frequency and a reception frequency of the first antenna unit A, a difference between a radiation frequency and a reception frequency of the second antenna unit B, and a difference between a radiation frequency and a reception frequency of the third antenna unit C, respectively; and k is the modulation slope of the linear frequency modulation continuous waves. Therefore, by calculating Δfa, Δfb and Δfc for the first antenna unit A, the second antenna unit B, and the third antenna unit C, the distance X1 between the finger and the first antenna unit A in the horizontal direction, the distance X2 between the finger and the second antenna unit B in the horizontal direction, and the distance X3 between the finger and the third antenna unit 23 in the horizontal direction may be calculated. The distance X1 between the finger and the first antenna unit A in the horizontal direction is X1=[(X₀−Xa)²+(Y₀−Ya)²]^{0.5}; the distance X2 between the finger and the second antenna unit B in the horizontal direction is X2=[(X₀−Xb)²+(Y₀−Yb)²]^{0.5}; and the distance X3 between the finger and the third antenna unit 23 in the horizontal direction is X3=[(X₀−Xc)²+(Y₀−Yc)²]^{0.5}, so that the coordinate O (X₀, Y₀) of the finger in the horizontal direction may be calculated according to preset values of Xa, Xb and Xc and Ya, Yb and Yc, and further is mapped onto the picture to be displayed by the display module, thereby realizing the touch control of the finger on the display module.

In this way, the touch function can be realized on the large-sized or ultra-large-sized display module with a low cost in the embodiment of the present disclosure. The electromagnetic wave radiated by the antenna units 23 covers the pixel unit 10 and the region above the pixel unit 10, so that the touch function can be realized when the finger does not touch the display module. Further, the display module can be controlled through gestures.

In some embodiments, in order to ensure the accuracy of the position information, a frequency band of the electromagnetic waves radiated by the antenna unit 23 is a millimeter-wave band. For example: a frequency of the electromagnetic waves radiated by the antenna unit 23 is 60 GHz.

In some embodiments, the antenna unit 23 is a directional antenna. Since the directional antenna has a single directivity, when processing the distance information between the finger and each antenna unit 23, a noise of the signal is small and the processing of the signal is simple. In some embodiments, each antenna unit 23 may be a yagi antenna 29 as shown in FIG. 6, due to the better directivity of the yagi antenna 29. In the following description, as an example, each antenna unit 23 is the yagi antenna 29.

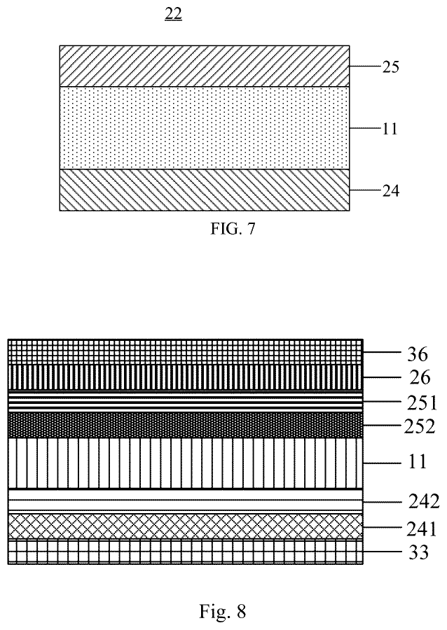

Specifically, in some embodiments, as shown in FIG. 7, the display panel 22 includes a first substrate 24 and a second substrate 25 disposed oppositely to each other, and the liquid crystal layer 11 disposed between the first substrate 24 and the second substrate 25. Each antenna unit 23 includes a first radiation part 261 integrated on the second substrate 25 and a reference electrode integrated on the first substrate 24, which are disposed oppositely to each other. In the embodiment of the present disclosure, each first radiation part 261 is configured to convert a signal fed therein into electromagnetic waves of the first frequency and receive electromagnetic waves reflected by the finger. Each reference electrode serves as a return path for the electric signals on a corresponding first radiation part 261. In this way, radiation and reception of the electromagnetic waves by the antenna unit 23 are achieved.

In some embodiments, each reference electrode may be electrically connected to the ground. In some embodiments, the first substrate 24 includes a first base substrate 241, and a driving layer 242 disposed on a side of the first base substrate 241 close to the liquid crystal layer 11. The driving layer 242 serves as reference electrodes of the antenna units 23. In the embodiment of the present disclosure, the driving layer 242 may be a driving circuit including a plurality of thin film transistors (TFTs) in each pixel unit 10 and configured to control a light emitting device in each pixel unit 10 to emit light. In this way, in the embodiment of the present disclosure, a new reference electrode layer is unnecessarily provided, reducing the process difficulty.

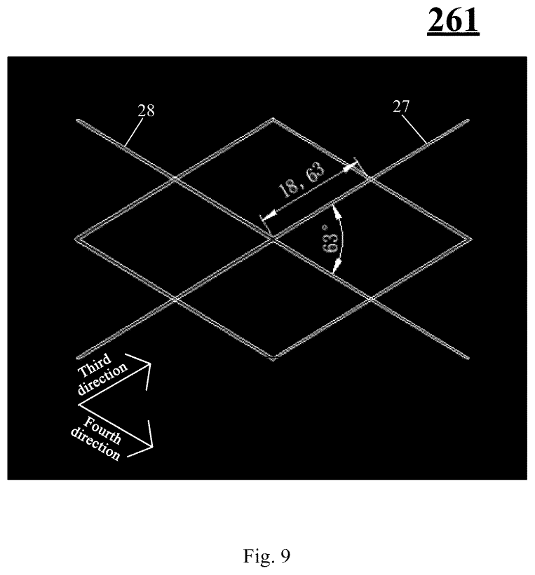

In some embodiments, the second substrate 25 includes a second base substrate 251, and a color filter layer 252 disposed on a side of the second base substrate 251 close to the liquid crystal layer 11, and the first radiation part 261 is disposed on a side of the second base substrate 251 away from the color filter layer 252. Specifically, as shown in FIG. 8, the display module includes a light guide plate 33 and the display panel 22 disposed on a side of the light guide plate 33; and the display panel 22 includes a first polarizer 34, the first substrate 24, the liquid crystal layer 11, the second substrate 25, the plurality of first radiation parts 261, and a second polarizer 36, which are sequentially disposed on a side of the light guide plate 33 in a direction away from the light guide plate 33. The light guide plate 33 is configured to transmit light generated by a light source into the display panel 22; the first polarizer 34 is configured to allow polarized light in a fifth direction to pass through; the first substrate 24 includes the first base substrate 241 and the driving layer 242 disposed away from the light guide plate 33, the driving layer 242 is configured to control a corresponding pixel unit 10 to emit light; the liquid crystal layer 11 is configured to regularly refract light passing through the liquid crystal layer under the control of an electric field loaded on the liquid crystal layer; the second substrate 25 includes the second base substrate 251 and the color filter layer 252 disposed toward the light guide plate 33, and the color filter layer 252 is configured to convert light emitted through the liquid crystal layer 11 into light of a corresponding color; the second polarizer 36 is configured to allow polarized light in a sixth direction to pass through; and the sixth direction is perpendicular to the fifth direction; each first radiation part 261 is configured to convert a signal fed into the first radiation part to electromagnetic waves of the first frequency and receive electromagnetic waves reflected by the finger. In this way, in the embodiment of the present disclosure, the loss of each antenna unit 23 is low.

In some embodiments, with continued reference to FIG. 8, the display module includes: a first radiation layer 26 integrated on the second substrate 25 and including a plurality of redundant radiation parts 262, each of which is positioned between the any two adjacent first radiation parts 261, and the redundant radiation parts 262 are separated apart from the first radiation parts 261. In the embodiment of the present disclosure, since the first radiation parts 261 are disposed on a side of the second base substrate 251 away from the color filter layer 252, the first radiation layer 26 is disposed on a side of the second base substrate 251 away from the color filter layer 252. In this way, the first radiation parts 261 and the redundant radiation parts 262 are easily installed in the display module. The redundant radiation parts 262 are provided, so that the display effect of the display module is ensured and the segment difference of the first radiation parts 261 is eliminated.

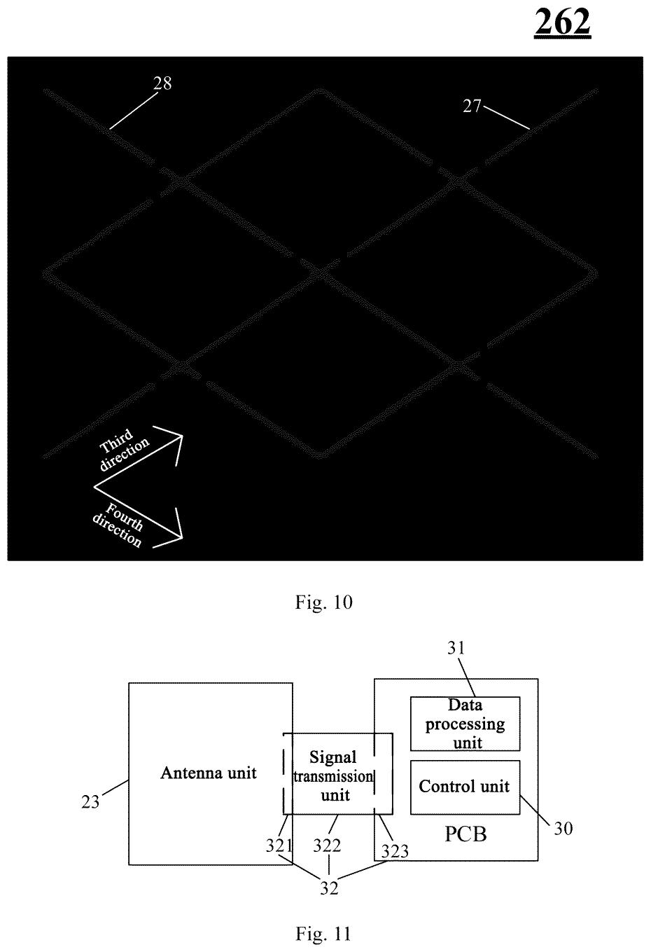

FIG. 9 is a schematic diagram of an enlarged part of a first radiation part 261 according to an embodiment of the present disclosure; FIG. 10 is a schematic diagram of an enlarged part of a redundant radiation part 262 according to an embodiment of the present disclosure. Specifically, as shown in FIGS. 9 and 10, in some embodiments, the first radiation layer 26 includes a metal mesh structure, including a plurality of first metal lines 27 and a plurality of second metal lines 28 crossing with the plurality of first metal lines 27; and the plurality of first metal lines 27 and the plurality of second metal lines 28 are broken at interface positions of the first radiation parts 261 and the redundant radiation parts 262. As shown in FIG. 9, each first metal line 27 extends in a third direction and each second metal line 28 in a fourth direction, and the plurality of second metal lines 28 cross with the plurality of first metal lines 27 to form a diamond-shaped mesh structure as shown in FIG. 9. An angle between the third and fourth directions may be in a range from 63° to 67°; a line width of each of the first metal lines 27 and the second metal lines 28 may be 5 microns±10%; a thickness of the first radiation layer 26 may be 1 micrometer±10%; a side of each diamond in the diamond-shaped mesh structure may be 18.63 microns. In this way, each first radiation part 261 cannot adversely influence the transmittance of the display module. That is, each first radiation part 261 cannot adversely influence the display effect of the display module. Therefore, it has realized a transparent antenna structure. Meanwhile, referring to FIG. 10, a size of each redundant radiation part 262 may be the same as that of the diamond-shaped mesh structure, and a space exists near a region where the first and second metal lines 27 and 28 intersect with each other in each redundant radiation part 262 to disconnect the first radiation parts 261 from the corresponding redundant radiation parts 262. In this way, each redundant radiation part 262 does not adversely influence the transmittance of the display module, and is easily manufactured. For example: a complete diamond-shaped metal mesh is formed, and then the region to be broken is cut by laser, so as to finally obtain the first radiation layer 26 including the redundant radiation parts 262 and the first radiation parts 261. In the embodiment of the present disclosure, by providing the redundant radiation parts 262, the display effect of the display module is ensured and the segment gap of the first radiation parts 261 is eliminated.

In some embodiments, as shown in FIG. 11, the display module further includes a control unit 30 and a data processing unit 31. The control unit 30 is configured to control each antenna unit 23 to radiate the electromagnetic waves of the first frequency and receive the electromagnetic waves reflected by the touch object according to a position of the touch object to be detected. The data processing unit 31 is configured to generate the position of the touch object to be detected according to the first frequency and a frequency of the electromagnetic waves reflected by the touch object. In the embodiment of the present disclosure, as shown in FIG. 11, the control unit 30 and the data processing unit 31 may be integrated in a system on a chip (SoC), which may be at least one or more of a field programmable gate array (FPGA), a central processing unit (CPU), a microcontroller unit (MCU) 30, and a digital signal processor (DSP). In the embodiment of the present disclosure, the hardware structures of the control unit 30 and the data processing unit 31 are provided on one PCB board.

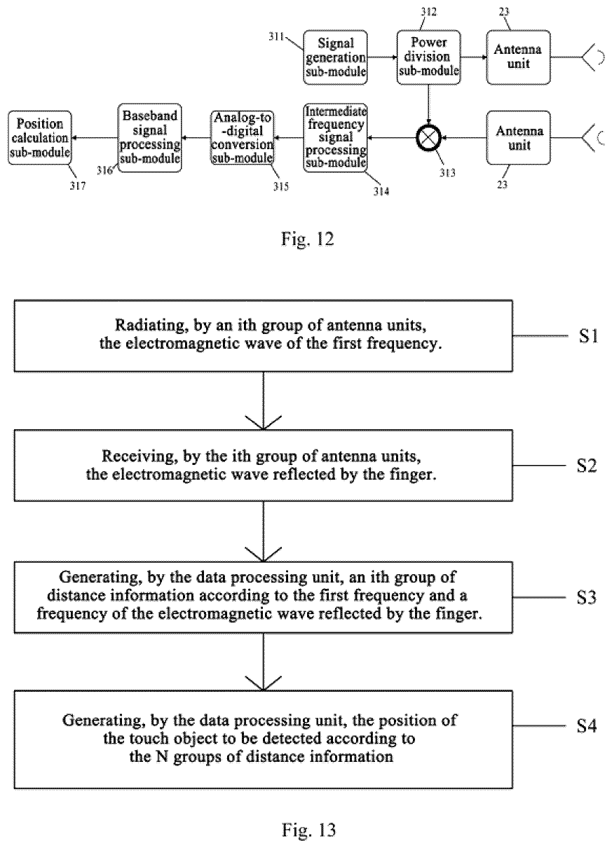

In some embodiments, as shown in FIG. 12, a specific structure of the data processing unit 31 may include a signal generation sub-module 311, a power division sub-module 312, a (frequency) mixing sub-module 313, an intermediate frequency signal processing sub-module 314, an analog-to-digital conversion sub-module 315, a baseband signal processing sub-module 316, and a position calculation sub-module 317. The signal generation sub-module 311 is configured to generate a first reference signal according to the first frequency. The power division sub-module 312 is configured to generate a first reference sub-signal according to the first reference signal. The mixing sub-module 313 is configured to generate a first mixing signal according to the reflected signal received by each antenna unit 23 and the first reference sub-signal. The intermediate frequency signal processing sub-module 314 is configured to generate a first intermediate frequency signal according to the first mixing signal. The analog-to-digital conversion sub-module 315 is configured to generate a first digital signal according to the first intermediate frequency signal. The baseband signal processing sub-module 316 is configured to generate the distance information according to the first digital signal. The position calculation sub-module 317 is configured to generate the position of the touch object to be detected according to a plurality of groups of the distance information.

Specifically, the signal generation sub-module 311 generates linear frequency modulation continuous waves as the first reference signal according to the first frequency of a signal to be radiated by each antenna unit 23, and transmits the first reference signal to the power division sub-module 312. The power division sub-module 312 divides the first reference signal into two identical first reference sub-signals, and a frequency of each first reference sub-signal includes the first frequency. One first reference sub-signal output by the power division sub-module 312 is amplified and filtered, and then transmitted to the antenna unit 23, which receives the first reference sub-signal, and then radiates the electromagnetic waves of the first frequency, and receives the electromagnetic waves reflected by the finger. The mixing sub-module 313 receives the electromagnetic waves reflected by the finger, and mixes the electromagnetic waves with one first reference sub-signal output by the power division sub-module 312 to generate the first mixing signal. At this time, the frequency of the first mixing signal may be a difference between a frequency of the electromagnetic waves reflected by the finger and a frequency of the first reference sub-signal. The intermediate frequency signal processing sub-module 314 receives and processes the first mixing signal to generate the first intermediate frequency signal. The analog-to-digital conversion sub-module 315 receives and converts the first intermediate frequency signal into the digital signal, and finally generates the first digital signal to be transmitted to the baseband signal processing sub-module 316. The baseband signal processing sub-module 316 receives and processes the first digital signal generated by the analog-to-digital conversion sub-module 315 to generate the distance information. The position calculation sub-module 317 generates the position of the touch object according to at least three groups of the distance information.

In some embodiments, as shown in FIG. 11, the display module further includes a signal transmission unit 32 configured to communicatively connects the PCB board and antenna units 23. Specifically, a first end of the signal transmission unit 32 is communicatively connected to the antenna units 23, and a second end of the signal transmission unit 32 is communicatively connected to the data processing unit 31 and the control unit 30. In this way, the signal transmission between the antenna units 23 and the PCB board is realized.

In some embodiments, the signal transmission unit 32 includes a first signal transmission part 321, a second signal transmission part 322, and a third signal transmission part 323 disposed between the first signal transmission part 321 and the second signal transmission part 322. The first signal transmission part 321 covers the first end of the signal transmission unit 32, and the second signal transmission part 322 covers the second end of the signal transmission unit 32. The third signal transmission part 323 includes a LCP base material and a signal line with a low loss. In some embodiments, the signal line may be a micro-strip line or a strip line. The first signal transmission part 321 and the second signal transmission part 322 include ACF glue, wherein a metal particle in the ACF glue has a larger diameter, which may be greater than 10 micrometers. The antenna units 23 and the signal line are bonded together through the ACF glue. In this way, in the embodiment of the present disclosure, the signal loss in the signal transmission unit 32 is low.

In a second aspect, the present disclosure provides an electronic terminal, which includes the display module according to the above embodiments. In some embodiments, the electronic terminal may be any one of a refrigerator, a washing machine, and a display device having a display function.

The display device provided by the embodiment of the present disclosure may be: any product or component with a display function, such as a flexible wearable device, a mobile phone, a tablet computer, a television, a display, a notebook computer, a digital photo frame, a navigator or the like. Other essential components of the display device are understood by one of ordinary skill in the art to be included, and are not described herein or should not be construed as limiting the invention.

In a third aspect, the present disclosure provides a position detection method, which may be applied to the display module described above. The display module includes N groups of antenna units 23. As shown in FIG. 13, the position detection method includes:
S1, radiating, by an ith group of antenna units 23, electromagnetic waves of a first frequency.
S2, receiving, by the ith group of antenna units 23, the electromagnetic waves reflected by a finger.
S3, generating, by the data processing unit 31, an ith group of distance information according to the first frequency and a frequency of the electromagnetic waves reflected by the touch object to be detected.
S4, generating, by the data processing unit 31, the position of the touch object to be detected according to the N groups of distance information; where 1≤i≤N, 3≤N; i and N are both positive integers.

In the embodiment of the present disclosure, the electromagnetic waves of the first frequency radiated by the ith group of antenna units 23 and the electromagnetic waves reflected by the touch object serve as an ith group of detection signals. The data processing unit 31 processes the ith group of detection signals to generate the distance information between the touch object and the ith group of antenna units 23, and generates the position of the touch object to be detected according to the N groups of distance information. In the embodiment of the present disclosure, in this way, the position of the touch object on the display module is detected by the antenna units 23, so that the touch function can be implemented on the large-sized or ultra-large-sized display module with a low cost. The electromagnetic waves radiated by the antenna units 23 covers the pixel unit 10 and the region above the pixel unit 10, so that the touch function can be realized when the finger does not touch the display module. Further, the display module can be controlled through gestures.

In some embodiments, the step of generating the distance information by each group of antenna units 23 may be performed independently, or may be performed at least partially simultaneously. As an example, each group of antenna units 23 generate the distance information in a time-division multiplexing manner for the description. The step of radiating the electromagnetic waves of the first frequency by a (j+1)th group of antenna units 23 and the step of generating the jth group of position information occur simultaneously; 1≤j<N; j is a positive integer.

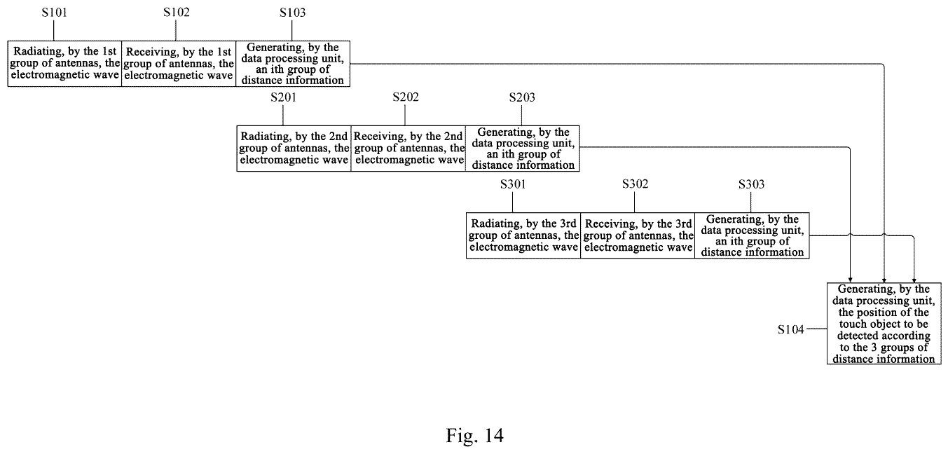

In the embodiment of the present disclosure, N may be 3, so j is 1 and 2, respectively. Hereinafter, only a case of N=3 and j=1, 2 will be described as an example. In this case, as shown in FIG. 14, the position detection method includes:
S101, radiating, by the 1st group of antenna units 23, electromagnetic waves of the first frequency.
S102, receiving, by the 1st group of antenna units 23, the electromagnetic waves reflected by the finger.
S103, generating, by the data processing unit 31, an ith group of distance information according to the first frequency and the frequency of the electromagnetic waves reflected by the finger.

When the step S103 occurs:
S201, radiating, by the 2nd group of antenna units 23, the electromagnetic waves of the first frequency.
S202, receiving, by the 2nd group of antenna units 23, the electromagnetic waves reflected by the finger.
S203, generating, by the data processing unit 31, an ith group of distance information according to the first frequency and the frequency of the electromagnetic waves reflected by the finger.

When the step S203 occurs:
S301, radiating, by the 3rd group of antenna units 23, the electromagnetic waves of the first frequency.
S302, receiving, by the 3rd group of antenna units 23, the electromagnetic waves reflected by the finger.
S303, generating, by the data processing unit 31, an ith group of distance information according to the first frequency and the frequency of the electromagnetic waves reflected by the finger.

After the step S303 is completed:
S4, generating, by the data processing unit 31, the position of the touch object to be detected according to the three groups of the distance information.

Thus, the position detection is performed once. In the embodiment of the present disclosure, the time required for performing the position detection once is shortened in a time-division multiplexing manner.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. A display module, comprising:
a display panel and a plurality of antenna units integrated on the display panel;
wherein the display panel comprises a plurality of pixel units; and
each pixel unit of the plurality of pixel units is covered by beams radiated by at least three antenna units of the plurality of antenna units at a center frequency.

2. The display module according to claim 1, wherein the display panel comprises a first substrate and a second substrate opposite to each other, and a liquid crystal layer between the first substrate and the second substrate;
each antenna unit of the plurality of antenna units comprises a first radiation part and a reference electrode opposite to each other; and
the first radiation part is integrated on the second substrate, and the reference electrode is integrated on the first substrate.

3. The display module according to claim 2, wherein the first substrate comprises a first base substrate and a driving layer on a side of the first base substrate close to the liquid crystal layer; and
the driving layer is used as reference electrodes of the plurality of antenna units.

4. The display module according to claim 2, wherein the second substrate comprises a second base substrate and a color filter layer on a side of the second base substrate close to the liquid crystal layer; and
the first radiation part is on a side of the first base substrate away from the color filter layer.

5. The display module according to claim 2, wherein a first radiation layer is integrated on the second substrate;
the first radiation part is in the first radiation layer;
the first radiation layer further comprises a plurality of redundant radiation parts, each of which is between the any two adjacent first radiation parts, and
the plurality of redundant radiation parts are separated apart from the first radiation parts.

6. The display module according to claim 5, wherein the first radiation layer comprises a metal mesh structure;
the metal mesh structure comprises a plurality of first metal lines and a plurality of second metal lines crossing with the plurality of first metal lines; and
the plurality of first metal lines and the plurality of second metal lines are broken at interface positions between the first radiation parts and the redundant radiation parts.

7. The display module according to claim 1, wherein the antenna unit is a directional antenna.

8. The display module according to claim 7, wherein the antenna unit is a Yagi-Uda antenna.

9. The display module according to claim 1, wherein a frequency band of electromagnetic waves radiated by the antenna unit is a millimeter-wave band.

10. The display module according to claim 1, further comprising: a control unit and a data processing unit;
wherein the control unit is configured to control the antenna unit to radiate electromagnetic waves of a first frequency and receive reflected electromagnetic waves reflected by a touch object to be detected according to a position of the touch object, and
the data processing unit is configured to generate the position of the touch object to be detected according to the first frequency and a frequency of the reflected electromagnetic waves.

11. The display module according to claim 1, further comprising: a signal transmission unit; wherein
a first end of the signal transmission unit is communicatively connected to the plurality of antenna units; and
a second end of the signal transmission unit is communicatively connected to the data processing unit and/or the control unit.

12. The display module according to claim 11, wherein the signal transmission unit comprises a first signal transmission part, a second signal transmission part, and a third signal transmission part between the first signal transmission part and the second signal transmission part;
the first signal transmission part covers the first end of the signal transmission unit;
the second signal transmission part covers the second end of the signal transmission unit;
the first signal transmission part and the second signal transmission part comprise ACF glue; and
the third signal transmission part comprises an LCP base material and a signal line.

13. The display module according to claim 12, wherein the signal line comprises at least one of a micro-strip line or a strip line.

14. The display module according to claim 10, wherein the data processing unit comprises a signal generation sub-module, a power division sub-module, a mixing sub-module, an intermediate frequency signal processing sub-module, an analog-to-digital conversion sub-module, a baseband signal processing sub-module, and a position calculation sub-module;
the signal generation sub-module is configured to generate a first reference signal according to the first frequency;
the power division sub-module is configured to generate a first reference sub-signal according to the first reference signal; a frequency of the first reference sub-signal comprises the first frequency;
the mixing sub-module is configured to generate a first mixing signal according to the reflected signal received by the antenna unit and the first reference sub-signal;
the intermediate frequency signal processing sub-module is configured to generate a first intermediate frequency signal according to the first mixing signal;
the analog-to-digital conversion sub-module is configured to generate a first digital signal according to the first intermediate frequency signal;
the baseband signal processing sub-module is configured to generate distance information according to the first digital signal; and
the position calculation sub-module is configured to generate the position of the touch object to be detected according to a plurality of groups of the distance information.

15. A position detection method for a display module, wherein the display module comprises:
a display panel and a plurality of antenna units integrated on the display panel;
wherein the display panel comprises a plurality of pixel units; and
each pixel unit of the plurality of pixel units is covered by beans radiated by at least three antenna units of the plurality of antenna unity at a center frequency, and
the display module comprises N groups of antenna units, and the position detection method comprises:
radiating, by an ith group of antenna units, electromagnetic waves of the first frequency;
receiving, by the ith group of antenna units, electromagnetic waves of a second frequency;
generating, by the data processing unit, an ith group of distance information according to the first frequency and the second frequency; and
generating, by the data processing unit, a position of the touch object to be detected according to N groups of the distance information; where 1≤i≤N, 3≤N; i and N are both positive integers.

16. The position detection method according to claim 15, wherein radiating the electromagnetic waves of the first frequency by a (j+1)th group of antenna units and generating a jth group of position information are performed simultaneously; where 1≤j<N; j is a positive integer.

17. An electronic terminal, comprising a display module,
wherein the display module comprises:
a display panel and a plurality of antenna units integrated on the display panel,
wherein the display panel comprises a plurality of pixel units; and
each pixel unit of the plurality of pixel units is covered by beams radiated by at least three antenna units of the plurality of antenna units at a center frequency.

18. The electronic terminal according to claim 17, wherein the electronic terminal comprises any one of a refrigerator, a washing machine, and a display device.

19. The electronic terminal according to claim 17, wherein the display panel comprises a first substrate and a second substrate opposite to each other, and a liquid crystal layer between the first substrate and the second substrate;
each antenna unit of the plurality of antenna units comprises a first radiation part and a reference electrode opposite to each other; and
the first radiation part is integrated on the second substrate, and the reference electrode is integrated on the first substrate.

20. The electronic terminal according to claim 19, wherein the first substrate comprises a first base substrate and a driving layer on a side of the first base substrate close to the liquid crystal layer; and
the driving layer is used as reference electrodes of the plurality of antenna units.
